(19) United States
(12) Patent Application Publication
(10) Pub. No.: US 2026/0082333 A1
(43) Pub. Date: Mar. 19, 2026

(54) IN-VEHICLE APPARATUS, CONNECTION DESTINATION NOTIFICATION METHOD, AND CONNECTION DESTINATION NOTIFICATION PROGRAM

(71) Applicants: AUTONETWORKS TECHNOLOGIES, LTD., Yokkaichi-shi (JP); SUMITOMO WIRING SYSTEMS, LTD., Yokkaichi-shi (JP); SUMITOMO ELECTRIC INDUSTRIES, LTD., Osaka (JP); TOYOTA JIDOSHA KABUSHIKI KAISHA, Toyota-shi (JP)

(72) Inventors: Kentaro ASHIBE, Yokkaichi-shi (JP); Tomohiro OTSU, Yokkaichi-shi (JP); Takehiro KAWAUCHI, Yokkaichi-shi (JP); Shu ISHIZUKA, Toyota-shi (JP); Yoshinobu KUROYA, Toyota-shi (JP); Kazuya SUGIYAMA, Toyota-shi (JP); Daisuke TAKAISHI, Toyota-shi (JP); Shingo TOMIDA, Toyota-shi (JP); Hiroya ANDOU, Toyota-shi (JP)

(73) Assignees: AUTONETWORKS TECHNOLOGIES, LTD., Yokkaichi-shi (JP); SUMITOMO WIRING SYSTEMS, LTD., Yokkaichi-shi (JP); SUMITOMO ELECTRIC INDUSTRIES, LTD., Osaka (JP); TOYOTA JIDOSHA KABUSHIKI KAISHA, Toyota-Shi (JP)

(21) Appl. No.: 19/325,646

(22) Filed: Sep. 11, 2025

(30) Foreign Application Priority Data
Sep. 19, 2024 (JP) 2024-161915

(51) Int. Cl. H04W 52/02; B60R 16/023; H04W 4/48

(52) U.S. Cl. CPC H04W 52/0251; B60R 16/023; H04W 4/48; H04W 52/0203; H04W 52/0219

(57) ABSTRACT

An in-vehicle apparatus includes: a detection unit configured to, in a state where existing devices each being an in-vehicle device are connected to an in-vehicle relay apparatus of the plurality of in-vehicle relay apparatuses, detect addition of an in-vehicle device other than the existing devices to the in-vehicle network; and a notification unit configured to, when a target relay apparatus, which is the in-vehicle relay apparatus to which the existing devices are connected, needs to exit the power saving mode due to a new device, which is an in-vehicle device and whose addition has been detected by the detection unit, having been newly connected to the target relay apparatus, perform notification processing to provide a notification indicating that a connection destination of the new device is to be changed to an in-vehicle relay apparatus other than the target relay apparatus, of the plurality of in vehicle relay apparatuses.

### CROSS-REFERENCE TO RELATED APPLICATIONS

This application claims priority of Japanese Patent Application No. JP 2024-161915 filed on Sep. 19, 2024, the contents of which are incorporated herein.

### TECHNICAL FIELD

The present disclosure relates to an in-vehicle apparatus, a connection destination notification method, and a connection destination notification program.

### BACKGROUND

JP 2018-074243A discloses the following technique. Specifically, a relay device includes: a plurality of ports (P1 to P5) through which frames are transmitted and received; a switch section (31) that includes a relay execution section that executes relay processing for selecting, based on the destination of a received frame that is a frame received via one of the plurality of ports, one of the plurality of ports as a relay destination of the received frame, and transmitting the received frame through the selected port, and that can switch between a first activated state where the relay execution section can execute the relay processing and a first suspended state where the relay execution section cannot execute the relay processing; a plurality of PHY sections (Y1 to Y5) that are respectively set in correspondence with the plurality of ports, each include a communication execution section that executes a receiving function for converting a communication signal input from the port into received data, and outputting the received data to the switch section and a transmission function for converting data transmitted from the switch section into a communication signal that is to be transmitted on a communication line, and outputting the communication signal to the port, and that can switch between a second activated state where the communication execution section can execute the receiving function and the transmission function and a second suspended state where the communication execution section cannot execute the receiving function and the transmission function; a first control section (37) configured to, when the switch section is in the first suspended state and the plurality of PHY sections are in the second suspended state, change a PHY section corresponding to a port on which a frame was detected from the second suspended state to the second activated state; and a second control section (38) configured to, when the switch section is in the first suspended state and the plurality of PHY sections are in the second suspended state and one of the plurality of PHY sections changes from the second suspended state to the second activated state, change the switch section from the first suspended state to the first activated state.

A technology has been developed to reduce power consumption by controlling the sleep mode of in-vehicle apparatuses in an in-vehicle system.

In an in-vehicle network including a plurality of in-vehicle relay apparatuses, there are cases where an in-vehicle device is newly connected to a certain in-vehicle relay apparatus. Depending on which in-vehicle relay apparatus the new in-vehicle device is connected to, it may be necessary to wake up other in vehicle relay apparatuses that are in sleep mode in order to execute the service using the device. In such cases, power consumption in the in-vehicle network will further increase.

The present disclosure is made to solve the above-described problem, and aims to provide an in-vehicle apparatus, a connection destination notification method, and a connection destination notification program that can improve the power saving function of an in-vehicle network.

### SUMMARY

An in-vehicle apparatus according to the present disclosure is an in-vehicle apparatus used in an in-vehicle network that includes a plurality of in-vehicle relay apparatuses that relay frames transmitted and received between in-vehicle devices, each of the plurality of in-vehicle relay apparatuses being configured to operate in a power saving mode when a predetermined condition is satisfied, the in-vehicle apparatus including: a detection unit configured to, in a state where existing devices each being an in-vehicle device are connected to an in-vehicle relay apparatus of the plurality of in vehicle relay apparatuses, detect addition of an in-vehicle device other than the existing devices to the in-vehicle network; and a notification unit configured to, when a target relay apparatus, which is the in-vehicle relay apparatus to which the existing devices are connected, needs to exit the power saving mode due to a new device, which is an in-vehicle device and whose addition has been detected by the detection unit, having been newly connected to the target relay apparatus, perform notification processing to provide a notification indicating that a connection destination of the new device is to be changed to an in-vehicle relay apparatus other than the target relay apparatus, of the plurality of in-vehicle relay apparatuses.

One aspect of the present disclosure can be realized not only as an in-vehicle device that includes such characteristic processing units, but also as a semiconductor integrated circuit that realizes a part or the entirety of the in-vehicle device, or a system that includes the in-vehicle device.

### Effects of the Present Disclosure

With the present disclosure, the power saving function of the in-vehicle network can be improved.

### BRIEF DESCRIPTION OF THE DRAWINGS

FIG. 1 is a diagram illustrating an example of a configuration of an in-vehicle system according to an embodiment of the present disclosure.

FIG. 2 is a diagram illustrating an example of a sequence of sleep control in the in-vehicle system according to the embodiment of the present disclosure.

FIG. 3 is a diagram illustrating an example of the configuration of an in-vehicle relay apparatus according to the embodiment of the present disclosure.

FIG. 4 is a diagram illustrating an example of the configuration of a new network in an in-vehicle system according to the embodiment of the present disclosure.

FIG. 5 is a diagram illustrating an example of a PNC list held by an in-vehicle relay apparatus according to the embodiment of the present disclosure.

FIG. 6 is a diagram illustrating an example of the configuration of an in-vehicle relay apparatus according to the embodiment of the present disclosure.

FIG. 7 is a diagram illustrating an example of a PNC list held by an in-vehicle relay apparatus according to the embodiment of the present disclosure.

FIG. 8 is a diagram showing an example of a screen displayed on the navigation apparatus in the in-vehicle system according to the embodiment of the present disclosure.

FIG. 9 is a diagram illustrating another example of the configuration of the in-vehicle system according to the embodiment of the present disclosure.

FIG. 10 is a diagram illustrating another example of the PNC list held by the in-vehicle relay apparatus according to the embodiment of the present disclosure.

FIG. 11 is a diagram illustrating an example of the configuration of an in-vehicle relay apparatus according to the embodiment of the present disclosure.

FIG. 12 is a diagram illustrating an example of an updated PNC list held by the in-vehicle relay apparatus according to the embodiment of the present disclosure.

FIGS. 13, 14, and 15 are flowcharts defining an example of an operation procedure when an in-vehicle relay apparatus according to the embodiment of the present disclosure performs notification processing.

FIG. 16 is a flowchart defining an example of an operation procedure through which the in-vehicle relay apparatus according to the embodiment of the present disclosure performs processing to transmit PNC information.

FIG. 17 is a diagram illustrating an example of a processing sequence of in-vehicle relay apparatuses and in-vehicle devices in the in-vehicle system according to the embodiment of the present disclosure.

### DETAILED DESCRIPTION OF PREFERRED EMBODIMENTS

First, the details of an embodiment of the present disclosure are listed and described.

In a first aspect, an in-vehicle apparatus according to an embodiment of the present disclosure is an in-vehicle apparatus used in an in-vehicle network that includes a plurality of in vehicle relay apparatuses that relay frames transmitted and received between in-vehicle devices, each of the plurality of in-vehicle relay apparatuses being configured to operate in a power saving mode when a predetermined condition is satisfied, the in-vehicle apparatus including: a detection unit configured to, in a state where existing devices each being an in-vehicle device are connected to an in-vehicle relay apparatus of the plurality of in-vehicle relay apparatuses, detect addition of an in-vehicle device other than the existing devices to the in-vehicle network; and a notification unit configured to, when a target relay apparatus, which is the in-vehicle relay apparatus to which the existing devices are connected, needs to exit the power saving mode due to a new device, which is an in-vehicle device and whose addition has been detected by the detection unit, having been newly connected to the target relay apparatus, perform notification processing to provide a notification indicating that a connection destination of the new device is to be changed to an in-vehicle relay apparatus other than the target relay apparatus, of the plurality of in-vehicle relay apparatuses.

With such a configuration, the user can easily confirm that the connection destination of the new device is not appropriate from the perspective of reducing power consumption in the in-vehicle network, and can change the connection destination of the new device to an appropriate connection destination. Therefore, the power saving function of the in-vehicle network can be improved.

In a second aspect according to the first aspect, a configuration is possible in which, the notification unit performs the notification processing when an in-vehicle device with a new PNCID different from PNCIDs of the existing devices is connected to the target relay apparatus as the new device, the PNCIDs conforming to the AUTOSAR standard.

With this configuration, based on the result of a comparison between the ID of the network to which in-vehicle devices already connected to an in-vehicle relay apparatus belong and the ID of the network to which the new device belongs, it is possible to appropriately determine whether or not the in-vehicle relay apparatus needs to exit the power saving mode, i.e., whether or not it is necessary to perform notification processing.

In a third aspect according to the first or the second aspect, a configuration is possible in which, the notification unit performs the notification processing when the target relay apparatus needs to exit the power saving mode and an in-vehicle device with the same PNCID as a new PNCID different from PNCIDs of the existing devices is connected to another in-vehicle relay apparatus of the plurality of in-vehicle relay apparatuses, the PNCIDs conforming to the AUTOSAR standard, and the notification unit does not perform the notification processing when the target relay apparatus needs to exit the power saving mode and no in-vehicle device with the same PNCID as the new PNCID is connected to another in-vehicle relay apparatus of the plurality of in-vehicle relay apparatuses.

With this configuration, depending on whether or not an in-vehicle device belonging to the same network as the network to which the new device belongs is connected to another in-vehicle relay apparatus, it is possible to appropriately determine whether or not to perform notification processing.

In a fourth aspect according to any of the first to the third aspects, a configuration is possible in which, the in-vehicle apparatus further including: a request unit configured to, when an in-vehicle device with a new PNCID different from PNCIDs of the existing devices is connected to the target relay apparatus as the new device, perform processing to request information regarding PNCIDs of in-vehicle devices already connected to another in-vehicle relay apparatus of the plurality of in-vehicle relay apparatuses, from the other in-vehicle relay apparatus, the PNCIDs conforming to the AUTOSAR standard.

With this configuration, in an in-vehicle system in which in-vehicle devices connected to another in-vehicle relay apparatus can be changed, it is possible to easily check whether or not an in-vehicle device belonging to the same network as the network to which the new device belongs is connected to the other in-vehicle relay apparatus.

In a fifth aspect according to any of the above first to the fourth aspects, a configuration is possible in which, the in-vehicle apparatus including one of the plurality of in-vehicle relay apparatuses, the in-vehicle apparatus further including: a receiving unit configured to receive request information for requesting PNC information regarding PNCIDs of in-vehicle devices already connected to an in-vehicle relay apparatus of the plurality of in-vehicle relay apparatuses, from the in-vehicle apparatus, the PNCIDs conforming to the AUTOSAR standard; and a response unit configured to, when the receiving unit receives the request information, transmit the PNC information to an origin from which the request information has been transmitted.

With this configuration, in an in-vehicle system in which in-vehicle devices connected to another in-vehicle relay apparatus can be changed, it is possible to easily check whether or not an in-vehicle device belonging to the same network as the network to which the new device belongs is connected to the other in-vehicle relay apparatus.

In a sixth aspect according to any of the first to the fifth aspects, a configuration is possible in which, in the notification processing, the notification unit further provides a notification of information regarding power saving of a vehicle in which the in-vehicle apparatus is mounted.

With this configuration, for example, the user can recognize that the power saving effect in the vehicle will be reduced due to the connection of a new device to the target relay apparatus.

In a seventh aspect, a connection destination notification method according to an embodiment of the present disclosure is a connection destination notification method for an in-vehicle apparatus used in an in-vehicle network that includes a plurality of in-vehicle relay apparatuses that relay frames transmitted and received between in-vehicle devices, each of the plurality of in-vehicle relay apparatuses being configured to operate in a power saving mode when a predetermined condition is satisfied, the connection destination notification method including the steps of: in a state where existing devices each being an in-vehicle device are connected to an in-vehicle relay apparatus of the plurality of in-vehicle relay apparatuses, detecting addition of an in-vehicle device other than the existing devices to the in-vehicle network; and when a target relay apparatus, which is the in-vehicle relay apparatus to which the existing devices are connected, needs to exit the power saving mode due to a new device, which is an in-vehicle device and whose addition has been detected, having been newly connected to the target relay apparatus, performing notification processing to provide a notification indicating that a connection destination of the new device is to be changed to an in-vehicle relay apparatus other than the target relay apparatus, of the plurality of in-vehicle relay apparatuses.

With such a method, the user can easily confirm that the connection destination of the new device is not appropriate from the perspective of reducing power consumption in the in-vehicle network, and can change the connection destination of the new device to an appropriate connection destination. Therefore, the power saving function of the in-vehicle network can be improved.

In an eighth aspect, a connection destination notification program according to an embodiment of the present disclosure is a connection destination notification program to be used in an in-vehicle apparatus used in an in-vehicle network that includes a plurality of in-vehicle relay apparatuses that relay frames transmitted and received between in-vehicle devices, each of the plurality of in-vehicle relay apparatuses being configured to operate in a power saving mode when a predetermined condition is satisfied, the connection destination notification program enabling a computer to function as: a detection unit configured to, in a state where existing devices, which are the in-vehicle devices, are connected to an in-vehicle relay apparatus of the plurality of in-vehicle relay apparatuses, detect addition of an in-vehicle device other than the existing devices to the in-vehicle network; and a notification unit configured to, when a target relay apparatus, which is the in-vehicle relay apparatus to which the existing devices are connected, needs to exit the power saving mode due to a new device, which is an in-vehicle device and whose addition has been detected by the detection unit, having been newly connected to the target relay apparatus, perform notification processing to provide a notification indicating that a connection destination of the new device is to be changed to an in-vehicle relay apparatus other than the target relay apparatus, of the plurality of in-vehicle relay apparatuses.

With such a configuration, the user can easily confirm that the connection destination of the new device is not appropriate from the perspective of reducing power consumption in the in-vehicle network, and can change the connection destination of the new device to an appropriate connection destination. Therefore, the power saving function of the in-vehicle network can be improved.

Hereinafter, embodiments of the present disclosure will be described with reference to the drawings. Note that, in the drawings, the same reference numerals are given to the same or corresponding components in the drawings, and redundant descriptions thereof are not repeated. Furthermore, at least parts of the embodiments described below may be suitably combined.

### In-Vehicle System

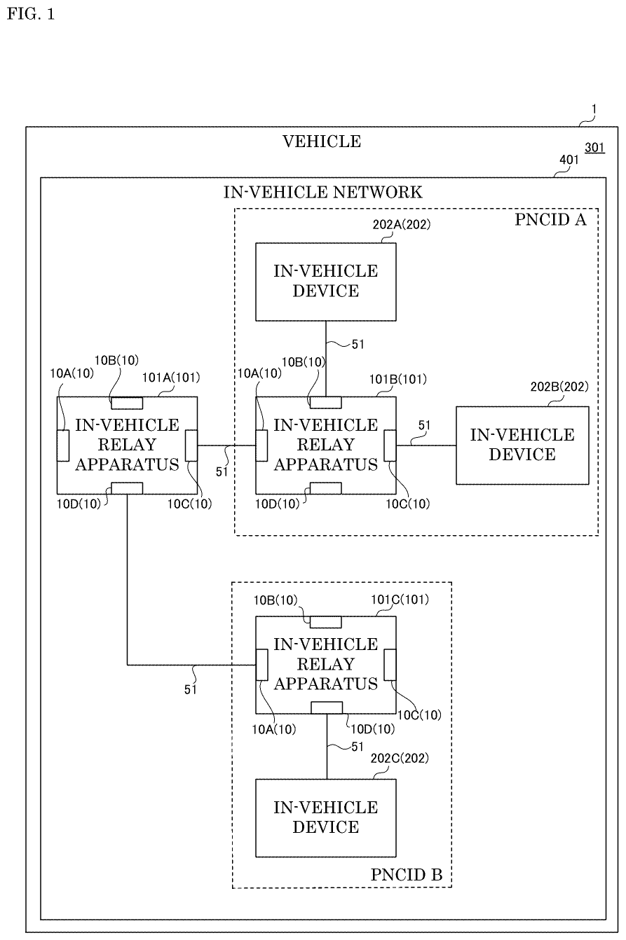

FIG. 1 is a diagram illustrating an example of a configuration of an in-vehicle system according to an embodiment of the present disclosure. As shown in FIG. 1, an in-vehicle system 301 includes a plurality of in-vehicle relay apparatuses 101 and a plurality of in-vehicle devices 202. The in-vehicle system 301 is mounted in a vehicle 1. Each in-vehicle relay apparatus 101 is an example of the in-vehicle apparatus.

The in-vehicle devices 202 include an in-vehicle ECU (Electronic Control Unit), a sensor, an actuator, a navigation apparatus, a human-machine interface, a camera, and so on. The in-vehicle ECU includes a TCU (Telematics Communication Unit), an engine ECU, an autonomous driving ECU, a steering ECU, a brake ECU, and so on.

The plurality of in-vehicle relay apparatuses 101 and the plurality of in-vehicle devices 202 form an in-vehicle network 401.

In the example shown in FIG. 1, the in-vehicle system 301 includes in-vehicle relay apparatuses 101A, 101B, and 101C, which are instances of the in-vehicle relay apparatuses 101. In the example shown in FIG. 1, the in-vehicle system 301 includes in-vehicle devices 202A, 202B, and 202C, which are instances of the in-vehicle devices 202.

The in-vehicle devices 202 are each connected to any of the in-vehicle relay apparatuses 101 via an Ethernet (registered trademark) cable 51, for example.

In the example shown in FIG. 1, the in-vehicle devices 202A and 202B are connected to the in-vehicle relay apparatus 101B via the Ethernet cable 51. The in-vehicle device 202C is connected to the in-vehicle relay apparatus 101C via the Ethernet cable 51.

More specifically, each in-vehicle relay apparatus 101 has a plurality of communication ports 10. Each communication port 10 is a connector to which the Ethernet cable 51 can be connected. In the example shown in FIG. 1, each in-vehicle relay apparatus 101 has communication ports 10A, 10B, 10C, and 10D, which are instances of the communication ports 10. Each communication port 10 is assigned a unique port number.

The in-vehicle devices 202A and 202B are connected to the communication ports 10B and 10C of the in-vehicle relay apparatus 101B via the Ethernet cable 51, respectively.

The in-vehicle device 202C is connected to the communication port 10D of the in-vehicle relay apparatus 101C via the Ethernet cable 51.

The in-vehicle relay apparatus 101A is connected to the in-vehicle relay apparatuses 101B and 101C via the Ethernet cable 51.

More specifically, the communication port 10C of the in-vehicle relay apparatus 101A and the communication port 10A of the in-vehicle relay apparatus 101B are connected via the Ethernet cable 51. The communication port 10D of the in-vehicle relay apparatus 101A and the communication port 10A of the in-vehicle relay apparatus 101C are connected via the Ethernet cable 51.

The in-vehicle relay apparatuses 101 and each in-vehicle device 202 communicate with each other to provide various services to the vehicle 1.

Specifically, services related to the autonomous driving of the vehicle 1 (hereinafter also referred to as “autonomous driving services”), services related to entertainment (hereinafter also referred to as “entertainment services”), services for detecting malfunctions in the vehicle 1, and so on are performed in the in-vehicle network 401.

Each in-vehicle device 202 transmits, to other in-vehicle devices 202, frames in which various types of information, such as information for assisting the autonomous driving performed by the vehicle 1 and information used for entertainment, are stored.

Each in-vehicle relay apparatus 101 used in the in-vehicle network 401 performs relay processing to relay frames transmitted and received between the in-vehicle devices 202.

The in-vehicle relay apparatuses 101 and the in-vehicle devices 202 operate using power supplied from the ignition power supply of the vehicle 1, for example.

Note that the in-vehicle system 301 is not limited to a configuration including three in-vehicle relay apparatuses 101, and may include two, four, or more in-vehicle relay apparatuses 101.

Also, each in-vehicle device 202 is not limited to being connected to the in-vehicle relay apparatuses 101 via the Ethernet cable 51, but may be connected to the in-vehicle relay apparatuses 101 via a transmission line that complies with other communication standards such as CAN (Controller Area Network), CAN FD (CAN with Flexible Data Rate), FlexRay (registered trademark), MOST (Media Oriented System Transport) (registered trademark), LIN (Local Interconnect Network), or CXPI (Clock Extension Peripheral Interface) (registered trademark).

### PNC

The in-vehicle relay apparatuses 101 and the in-vehicle devices 202 form a PNC (Partial Network Cluster), which is an example of a network, in accordance with the AUTOSAR (AUTomotive Open System ARchitecture) (registered trademark) standard.

In the example shown in FIG. 1, the in-vehicle relay apparatus 101B and the in-vehicle devices 202A and 202B form a PNC with a PNCID “A” that complies with the AUTOSAR standard. The in-vehicle relay apparatus 101C and the in-vehicle device 202C form a PNC with a PNCID “B”.

In the present embodiment, for example, the in-vehicle relay apparatus 101B and the in-vehicle devices 202A and 202B that belong to the PNC with the PNCID “A” provide autonomous driving services. The in-vehicle relay apparatus 101C and the in-vehicle device 202C that belong to the PNC with the PNCID “B” provide entertainment services.

### Wake-Up Mode and Sleep Mode

The in-vehicle relay apparatuses 101 and the in-vehicle devices 202 transition from wake-up mode to sleep mode, and transition from sleep mode to wake-up mode. The in-vehicle relay apparatuses 101 and the in-vehicle devices 202 communicate with other apparatuses (devices) in the in-vehicle system 301 in wake-up mode, and stop communication with other apparatuses (devices) in the in-vehicle system 301 in sleep mode. Specifically, sleep mode is a mode in which power consumption is lower than in wake-up mode due to factors such as the suspension of certain functions of the apparatuses (devices), the shutdown of power supply to the apparatuses (devices), or a reduction in clock frequency in the apparatuses (devices). Sleep mode is an example of the power saving mode.

The in-vehicle relay apparatuses 101 and the in-vehicle devices 202 each operate in wake-up mode when a predetermined wake-up condition is satisfied. Also, the in-vehicle relay apparatuses 101 and the in-vehicle devices 202 each operate in sleep mode when a predetermined sleep condition is satisfied.

Specifically, examples of wake-up conditions for each of the in-vehicle relay apparatuses 101 and each of the in-vehicle devices 202 include conditions such as the initiation of a service by the apparatus or device, the ignition of the vehicle 1 being turned on, and so on. Examples of sleep conditions for each of the in-vehicle relay apparatuses 101 and each of the in-vehicle devices 202 include conditions such as the completion of a service by the apparatus or device, the ignition of the vehicle 1 being turned off, and so on.

For example, in the in-vehicle network 401 shown in FIG. 1, when the in-vehicle relay apparatus 101B and the in-vehicle devices 202A and 202B belonging to the PNC with the PNCID “A” are executing an autonomous driving service, the in-vehicle relay apparatuses 101A and 101C and the in-vehicle device 202C, which do not belong to that PNC, do not need to operate in wake-up mode when there are no other services to be executed. In this case, in the in-vehicle network 401 shown in FIG. 1, the operation modes of the in-vehicle relay apparatuses 101A and 101C and the in-vehicle device 202C are each set to sleep mode.

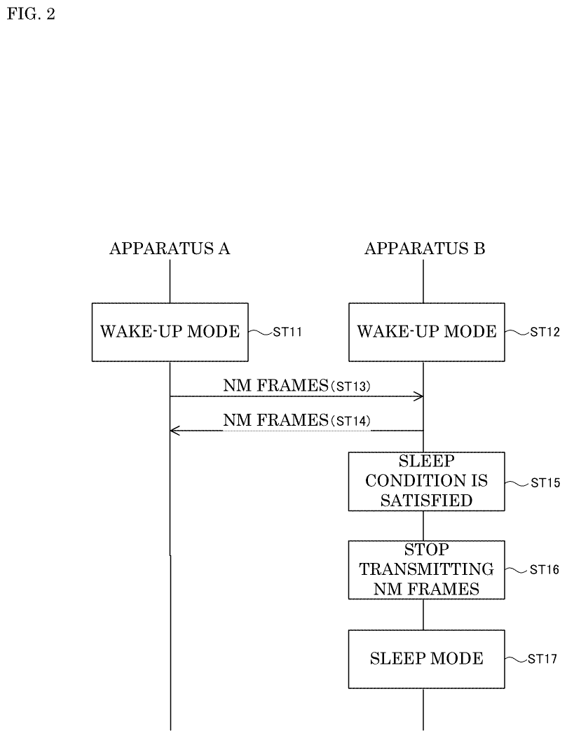

FIG. 2 is a diagram illustrating an example of a sequence of sleep control in the in-vehicle system according to the embodiment of the present disclosure. “APPARATUS A” and “APPARATUS B” shown in FIG. 2 are each an in-vehicle relay apparatus 101 or an in-vehicle device 202.

As shown in FIG. 2, first, in wake-up mode (steps ST11 and ST12), the apparatus A and apparatus B transmit, for example, Ethernet frames each including an NM (Network Management) message that conforms to the AUTOSAR standard (hereinafter also referred to as “NM frames”) to each other. Specifically, the apparatus A and the apparatus B transmit NM frames to each other for alive monitoring (steps ST13 and ST14).

Next, when the sleep condition for the apparatus B is satisfied in wake-up mode (step ST15), the apparatus B stops transmitting NM frames (step ST16).

Next, if no NM frame arrives from the apparatus A until a predetermined time has elapsed since the apparatus B stopped transmitting NM frames, the apparatus B transitions to sleep mode (step ST17).

Note that, in sleep mode (step ST17), if the wake-up condition for the apparatus B is satisfied, the apparatus B transitions to wake-up mode and starts regular transmission of NM frames. In sleep mode (step ST17), if the apparatus B receives a wake-up request from another apparatus (device) in the in-vehicle system 301, the apparatus B transitions to wake-up mode.

### In-Vehicle Relay Apparatus 101C

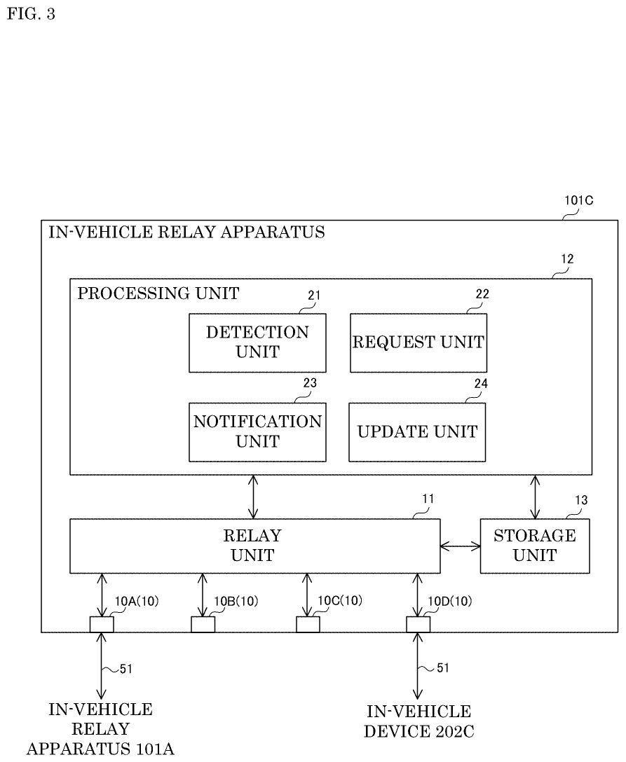

FIG. 3 is a diagram illustrating an example of the configuration of an in-vehicle relay apparatus according to the embodiment of the present disclosure. FIG. 3 shows the configuration of the in-vehicle relay apparatus 101C.

As shown in FIG. 3, the in-vehicle relay apparatus 101C includes a relay unit 11, a processing unit 12, and a storage unit 13. The processing unit 12 includes a detection unit 21, a request unit 22, a notification unit 23, and an update unit 24. One or both of the relay unit 11 and the processing unit 12 are realized using processing circuitry that includes one or more processors, for example. The storage unit 13 is, for example, a non-volatile memory included in the above processing circuitry.

The storage unit 13 stores an address table indicating the correspondence between the port numbers of the communication ports 10 and the MAC (Media Access Control) addresses of the apparatuses connected to the communication ports 10. The relay unit 11 performs relay processing, using the address table in the storage unit 13.

Upon receiving a frame addressed to the in-vehicle relay apparatus 101C, which includes the relay unit 11, from an in-vehicle device 202, the relay unit 11 outputs the received frame to the processing unit 12.

The processing unit 12 also creates a frame addressed to the in-vehicle relay apparatus 101A, the in-vehicle relay apparatus 101B, or the in-vehicle device 202, and outputs the created frame to the relay unit 11. When receiving the frame from the processing unit 12, the relay unit 11 transmits the frame to the destination apparatus.

### New Network

In the following description, the in-vehicle device 202 to be newly added to the in-vehicle network 401 is also referred to as a “new device,” and the in-vehicle network 401 including the new device is also referred to as a “new network”. In addition, the in-vehicle devices 202 included in the in-vehicle network 401 before the new device is added are also referred to as “existing devices”.

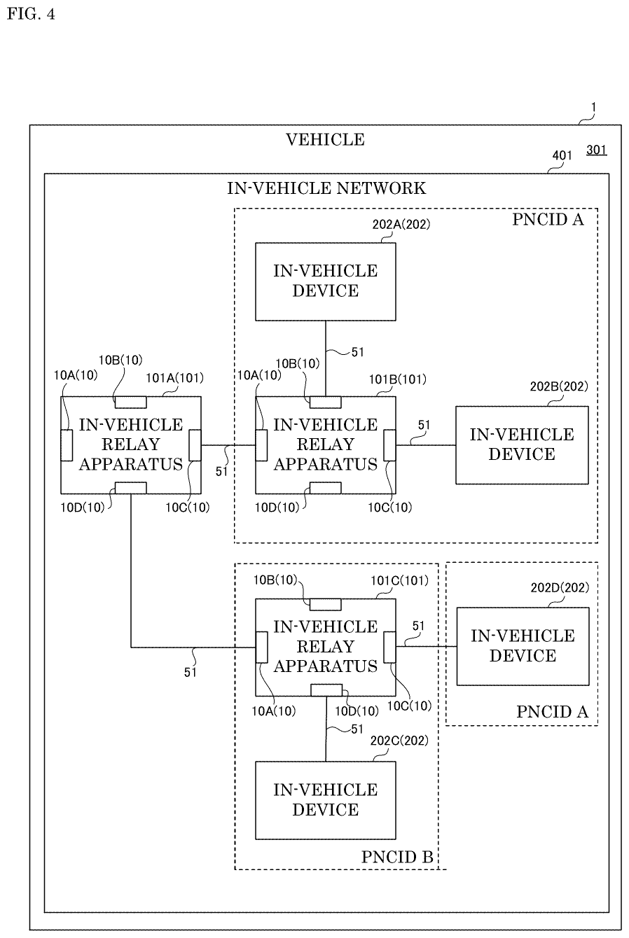

FIG. 4 is a diagram illustrating an example of the configuration of a new network in an in-vehicle system according to the embodiment of the present disclosure. FIG. 4 shows the configuration of the in-vehicle network 401 in which a new in-vehicle device 202D is newly added to the in-vehicle network 401 shown in FIG. 1.

As shown in FIG. 4, the in-vehicle device 202D is connected to the communication port 10C of the in-vehicle relay apparatus 101C via the Ethernet cable 51, for example.

### Description of Problem

For example, in the new network shown in FIG. 4, it is assumed that the PNCID of the in-vehicle device 202D connected to the in-vehicle relay apparatus 101C is “A”. In this case, in order to execute the autonomous driving services by the in-vehicle relay apparatus 101B and the in-vehicle devices 202A, 202B, and 202D belonging to the PNC with PNCID “A”, it is necessary to wake up the in-vehicle relay apparatuses 101A and 101C, which were in sleep mode, which further increases the power consumption in the in-vehicle network 401.

Therefore, the in-vehicle system 301 according to the embodiment of the present disclosure solves the above problem by the following configuration and operation.

### In-Vehicle Relay Apparatus 101C

### PNC List L11

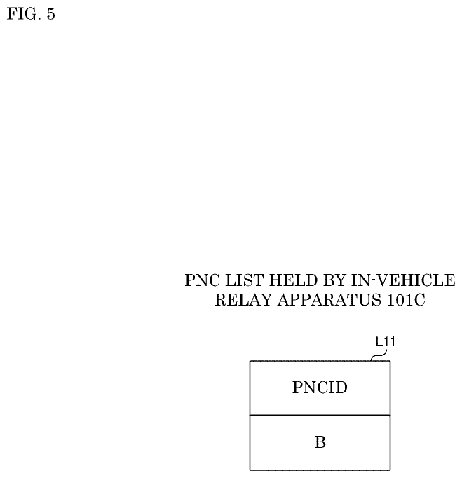

FIG. 5 is a diagram illustrating an example of a PNC list held by an in-vehicle relay apparatus according to the embodiment of the present disclosure. FIG. 5 shows a PNC list L11 held by the in-vehicle relay apparatus 101C.

As shown in FIG. 5, for example, in the in-vehicle relay apparatus 101C, the storage unit 13 stores the PNC list L11 indicating the PNCID(s) of one or more in-vehicle devices 202 connected to the in-vehicle relay apparatus 101C, which includes the storage unit 13.

The PNCID registered in the PNC list L11 shown in FIG. 5 is the PNCID of the in-vehicle device 202C, i.e., “B”.

### Detection Unit

FIGS. 3 and 4 are reference again. The detection unit 21 detects the addition of a new device to the in-vehicle network 401 in a state where existing devices are connected to the in-vehicle relay apparatus 101C, which includes the detection unit 21. Here, the detection unit 21 detects the addition of the in-vehicle device 202D in a state where the in-vehicle device 202C is connected to the in-vehicle relay apparatus 101C, which includes the detection unit 21.

More specifically, for example, when the in-vehicle relay apparatus 101C, which includes the detection unit 21, is started up, the detection unit 21 broadcasts a search message to each of the in-vehicle devices 202 connected to the in-vehicle relay apparatus 101C via the relay unit 11 to detect the addition of a new device.

When any of the in-vehicle devices 202 connected to the in-vehicle relay apparatus 101C receives the search message from the in-vehicle relay apparatus 101C, the in-vehicle device transmits an NM frame containing the device ID thereof to the in-vehicle relay apparatus 101C as a response to the search message. The device ID is identification information for identifying the in-vehicle device 202.

In the in-vehicle relay apparatus 101C, upon receiving the NM frame from the in-vehicle device 202, the relay unit 11 outputs the received NM frame to the detection unit 21.

For example, the storage unit 13 stores a device list L20 indicating one or more device IDs connected to the in-vehicle relay apparatus 101, which includes the storage unit 13.

Upon receiving an NM frame from the relay unit 11, the detection unit 21 checks whether or not the device ID contained in the NM frame is registered in the device list L20 in the storage unit 13.

If the device ID contained in the NM frame received from the relay unit 11 is registered in the device list L20, the detection unit 21 determines that the in-vehicle device 202 that transmitted the NM frame is an existing device.

On the other hand, if the device ID contained in the NM frame received from the relay unit 11 is not registered in the device list L20, the detection unit 21 determines that the in-vehicle device 202 that transmitted the NM frame is a new device.

Upon detecting the addition of a new device, the detection unit 21 transmits a request notification, indicating a request to transmit a PNCID, to the new device via the relay unit 11.

Upon receiving the request notification from the in-vehicle relay apparatus 101C, the new device transmits an NM frame containing the PNCID thereof to the in-vehicle relay apparatus 101C as a response to the received request notification.

In the in-vehicle relay apparatus 101C, upon detecting the addition of a new device, the detection unit 21 determines whether or not it is necessary to add the PNCID of the new device to the PNC list L11 in the storage unit 13.

More specifically, for example, upon receiving an NM frame from a new device via the relay unit 11, the detection unit 21 checks whether or not the PNCID contained in the received NM frame is registered in the PNC list L11 in the storage unit 13.

If the PNCID contained in the NM frame received from the new device is registered in the PNC list L11, the detection unit 21 determines that it is unnecessary to add the PNCID to the PNC list L11.

On the other hand, if the PNCID contained in the NM frame received from the new device is not registered in the PNC list L11, the detection unit 21 determines that it is necessary to add the PNCID to the PNC list L11. The PNCID is a new PNCID for the in-vehicle relay apparatus 101C (hereinafter also referred to as a “new PNCID”), that is, a PNCID different from the PNCID(s) of the existing device(s) connected to the in-vehicle relay apparatus 101C. In this way, when an in-vehicle device 202 with a new PNCID is connected to the in-vehicle relay apparatus 101C, the in-vehicle relay apparatus 101C needs to exit sleep mode in order to execute a service using the in-vehicle device 202.

As described above, in the example shown in FIG. 4, the PNCID of the in-vehicle device 202D is “A”. In this case, the detection unit 21 determines that the PNCID “A” needs to be added to the PNC list L11 because the PNCID “A” is not registered in the PNC list L11.

Upon determining that it is necessary to add the PNCID of the new device to the PNC list L11, the detection unit 21 outputs additional ID information indicating the PNCID, i.e., a new PNCID, to the request unit 22. Hereinafter, an example will be described in which the detection unit 21 outputs additional ID information indicating the PNCID “A” of the in-vehicle device 202D as a new PNCID, to the request unit 22.

### Transmission of Request Information

For example, when an in-vehicle device 202 with a new PNCID is connected to the in-vehicle relay apparatus 101C, which includes the request unit 22, as a new device, the request unit 22 performs processing to request PNC information regarding the PNCID of the already connected in-vehicle device 202 from in-vehicle relay apparatuses 101 other than the in-vehicle relay apparatus 101C.

More specifically, for example, upon receiving additional ID information from the detection unit 21, the request unit 22 transmits request information for requesting PNC information, to the other in-vehicle relay apparatuses 101.

For example, the storage unit 13 stores topology information that enables the topology in the in-vehicle network 401 to be recognized. Specifically, for example, the topology information indicates the IDs of in-vehicle relay apparatuses 101 other than the in-vehicle relay apparatus 101C in the in-vehicle network 401, i.e., the IDs of the in-vehicle relay apparatuses 101A and 101B.

Upon receiving the additional ID information from the detection unit 21, the request unit 22 references the topology information in the storage unit 13 to check the other in-vehicle relay apparatuses 101 to which request information is to be transmitted. In the present embodiment, for example, it is assumed that the request unit 22 first transmits request information to the in-vehicle relay apparatus 101B.

Specifically, for example, the request unit 22 transmits request information containing the new PNCID indicated by the additional ID information received from the detection unit 21, i.e., the PNCID “A” of the in-vehicle device 202D, to the in-vehicle relay apparatus 101B via the relay unit 11 and the in-vehicle relay apparatus 101A.

### In-Vehicle Relay Apparatus 101B

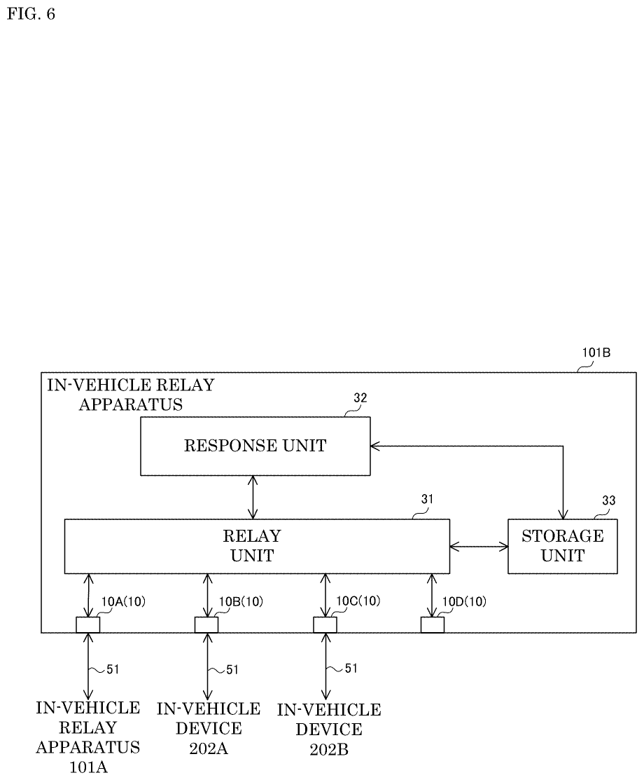

FIG. 6 is a diagram illustrating an example of the configuration of an in-vehicle relay apparatus according to the embodiment of the present disclosure. FIG. 6 shows the configuration of the in-vehicle relay apparatus 101B.

As shown in FIG. 6, the in-vehicle relay apparatus 101B includes a relay unit 31, a response unit 32, and a storage unit 33. One or both of the relay unit 31 and the response unit 32 are realized using processing circuitry that includes one or more processors, for example. The storage unit 33 is, for example, a non-volatile memory included in the above processing circuitry.

For example, upon receiving request information from the in-vehicle relay apparatus 101C via the in-vehicle relay apparatus 101A, the relay unit 31 outputs the received request information to the response unit 32.

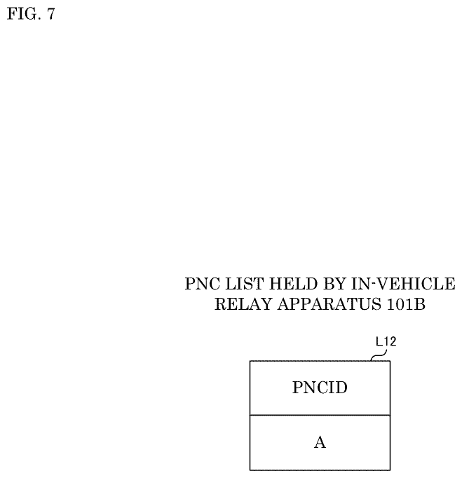

FIG. 7 is a diagram illustrating an example of a PNC list held by an in-vehicle relay apparatus according to the embodiment of the present disclosure. FIG. 7 shows a PNC list L12 held by the in-vehicle relay apparatus 101B.

As shown in FIG. 7, the storage unit 33 stores the PNC list L12 indicating the PNCID(s) of one or more in-vehicle devices 202 connected to the in-vehicle relay apparatus 101 of the storage unit 33.

The PNCID registered in the PNC list L12 shown in FIG. 7 is the PNCID of the in-vehicle devices 202A and 202B, i.e., “A”.

### Transmission of PNC Information

FIG. 6 is referenced again. For example, when the relay unit 31 receives request information, the response unit 32 transmits the PNC information to the origin from which the request information has been transmitted, i.e., the in-vehicle relay apparatus 101C.

More specifically, for example, upon receiving request information from the relay unit 31, the response unit 32 checks whether or not the new PNCID “A” indicated by the request information is registered in the PNC list L12 in the storage unit 33.

In the example shown in FIG. 7, the PNCID “A” indicated by the request information received by the relay unit 31 from the in-vehicle relay apparatus 101C is registered in the PNC list L12. In this case, the response unit 32 transmits PNC information (hereinafter also referred to as “PNC information P11”) indicating that the new PNCID is registered in the PNC list L12 to the in-vehicle relay apparatus 101C via the relay unit 31.

FIG. 2 is referenced again. In the in-vehicle relay apparatus 101C, upon receiving the PNC information P11 from the in-vehicle relay apparatus 101B via the in-vehicle relay apparatus 101A, the relay unit 11 outputs the received PNC information P11 to the notification unit 23.

### Notification Processing

For example, when a new device is newly connected to the in-vehicle relay apparatus 101C, which includes the notification unit 23, and the in-vehicle relay apparatus 101C needs to exit sleep mode, i.e., when an in-vehicle device 202 with a new PNCID is connected to the in-vehicle relay apparatus 101C, the notification unit 23 performs notification processing to provide a notification indicating that the connection destination of the new device is to be changed to an in-vehicle relay apparatus 101 other than the in-vehicle relay apparatus 101C and indicating information regarding the power saving of the vehicle 1.

More specifically, for example, the notification unit 23 performs the notification processing if the in-vehicle relay apparatus 101C, which includes the notification unit 23, needs to exit sleep mode and an in-vehicle device 202 with the same PNCID as the new PNCID is connected to another in-vehicle relay apparatus 101.

Specifically, upon receiving the PNC information P11 from the relay unit 11, the notification unit 23 determines that the in-vehicle device 202 with the same PNCID as the new PNCID is connected to the other in-vehicle relay apparatus 101, i.e., the in-vehicle relay apparatus 101B.

Thereafter, the notification unit 23 transmits connection destination information to an IVI (In-vehicle Infotainment) indicating that the connection destination of the new device is to be changed to the in-vehicle relay apparatus 101B and that the power efficiency of the vehicle 1 has decreased due to the connection of the new device to the in-vehicle relay apparatus 101C. Specifically, for example, the notification unit 23 transmits the connection destination information to a navigation apparatus (not shown) in the in-vehicle system 301 via the relay unit 11.

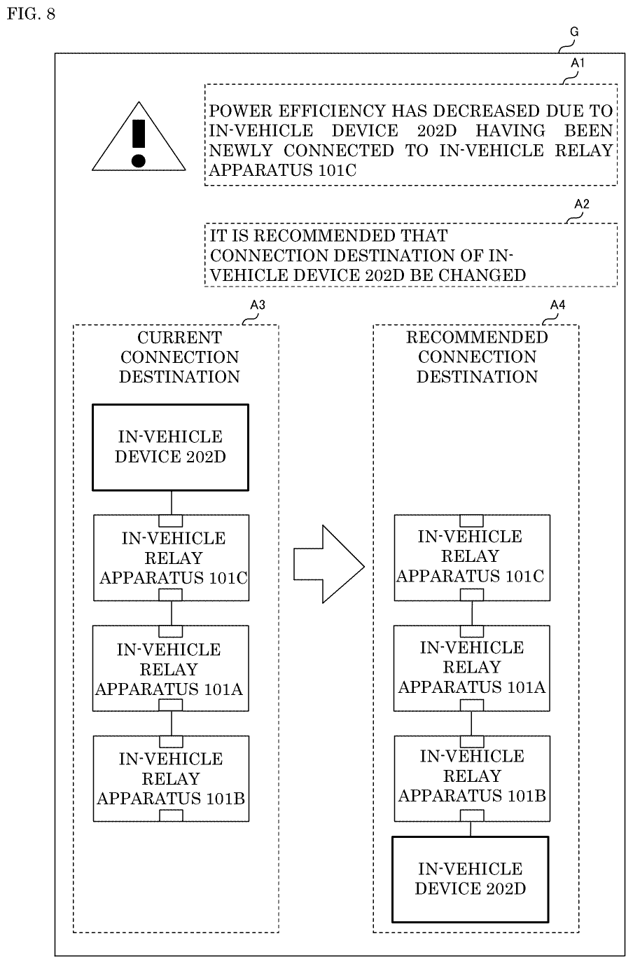

FIG. 8 is a diagram showing an example of a screen displayed on the navigation apparatus in the in-vehicle system according to the embodiment of the present disclosure.

As shown in FIG. 8, for example, upon receiving connection destination information from the in-vehicle relay apparatus 101C, the navigation apparatus displays a screen G showing the content of the connection destination information on the display unit of the navigation apparatus.

The screen G includes areas A1, A2, A3, and A4. The area A1 shows the content of information regarding power saving of the vehicle 1. In the example shown in FIG. 8, the area A1 indicates that the power efficiency of the vehicle 1 has decreased due to the connection of the in-vehicle device 202D to the in-vehicle relay apparatus 101C.

The area A2 indicates that it is recommended that the connection destination of the new device, i.e., the in-vehicle device 202D, be changed. The area A3 indicates the current connection destination of the in-vehicle device 202D in the in-vehicle network 401. The area A4 indicates the connection destination of the in-vehicle device 202D recommended by the in-vehicle relay apparatus 101C.

When In-Vehicle Device 202 with PNCID Different from New PNCID is Connected

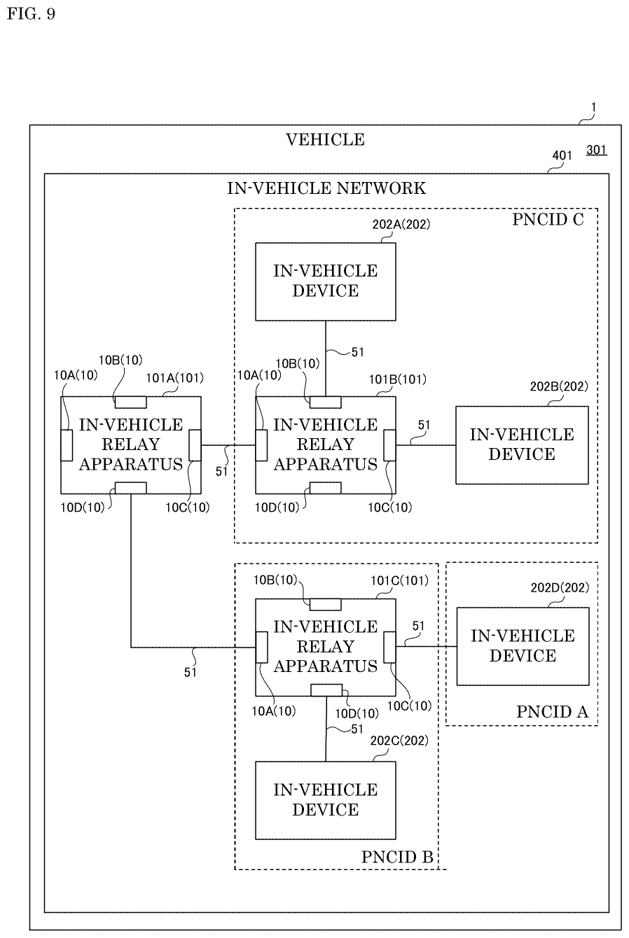

FIG. 9 is a diagram illustrating another example of the configuration of the in-vehicle system according to the embodiment of the present disclosure. In the in-vehicle system 301 shown in FIG. 9, compared to the in-vehicle system 301 shown in FIG. 1, the in-vehicle relay apparatus 101B and the in-vehicle devices 202A and 202B form a PNC with a PNCID “C”.

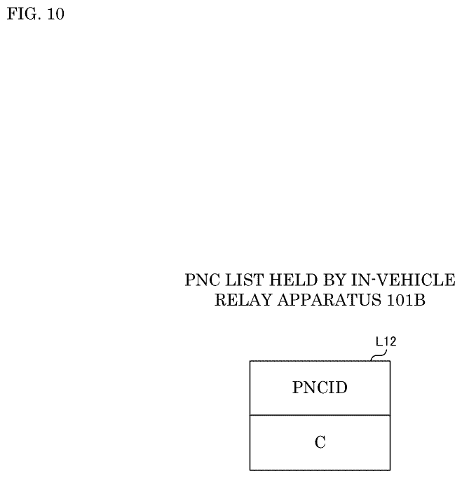

FIG. 10 is a diagram illustrating another example of the PNC list held by the in-vehicle relay apparatus according to the embodiment of the present disclosure. FIG. 10 shows another example of the PNC list L12 held by the in-vehicle relay apparatus 101B.

The PNCID registered in the PNC list L12 shown in FIG. 10 is “C”. That is to say, the PNCID is different from the PNCID “A” indicated by the request information received by the relay unit 31 from the in-vehicle relay apparatus 101C.

FIG. 6 is referenced again. In the in-vehicle relay apparatus 101B, if the new PNCID indicated by the request information received from the relay unit 31 is different from the PNCID registered in the PNC list L12, the response unit 32 transmits PNC information (hereinafter also referred to as “PNC information P12”) to the in-vehicle relay apparatus 101C, indicating that no in-vehicle device 202 with the same PNCID as the new PNCID is connected to the in-vehicle relay apparatus 101B, which includes the response unit 32.

Specifically, for example, if the new PNCID indicated by the request information received from the relay unit 31 is different from the PNCID registered in the PNC list L12, the response unit 32 transmits the PNC information P12 to the in-vehicle relay apparatus 101C via the relay unit 31 and the in-vehicle relay apparatus 101A.

FIG. 3 is referenced again. In the in-vehicle relay apparatus 101C, upon receiving the PNC information P12 from the in-vehicle relay apparatus 101B via the in-vehicle relay apparatus 101A and the relay unit 11, the request unit 22 transmits request information to the in-vehicle relay apparatus 101A via the relay unit 11.

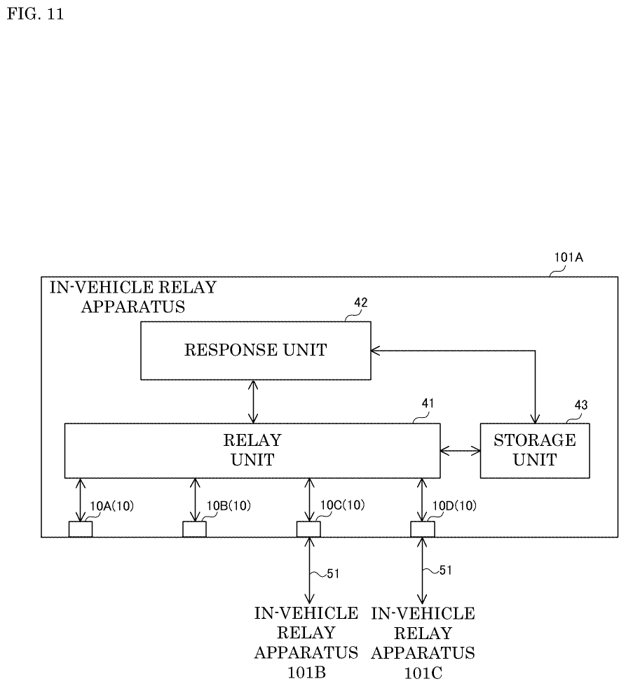

FIG. 11 is a diagram illustrating an example of the configuration of an in-vehicle relay apparatus according to the embodiment of the present disclosure. FIG. 11 shows the configuration of the in-vehicle relay apparatus 101A.

As shown in FIG. 11, the in-vehicle relay apparatus 101A includes a relay unit 41, a response unit 42, and a storage unit 43. One or both of the relay unit 41 and the response unit 42 are realized using processing circuitry that includes one or more processors, for example. The storage unit 43 is, for example, a non-volatile memory included in the above processing circuitry.

For example, upon receiving request information from the in-vehicle relay apparatus 101C, the relay unit 41 outputs the received request information to the response unit 42.

For example, when the relay unit 41 receives request information, the response unit 42 transmits the PNC information to the in-vehicle relay apparatus 101C.

Specifically, for example, upon receiving request information from the relay unit 11, the response unit 42 checks whether or not an in-vehicle device 202 with the same PNCID as the new PNCID indicated by the request information is connected to the in-vehicle relay apparatus 101A, which includes the response unit 42.

In the example shown in FIG. 9 described above, no in-vehicle device 202 is connected to the in-vehicle relay apparatus 101A. In this case, in the in-vehicle relay apparatus 101A, the response unit 42 transmits PNC information (hereinafter also referred to as “PNC information P21”) to the in-vehicle relay apparatus 101C via the relay unit 41, indicating that no in-vehicle device 202 with the same PNCID as the new PNCID indicated by the request information received from the relay unit 11 is connected to the in-vehicle relay apparatus 101A, which includes the response unit 42.

FIG. 3 is referenced again. In the in-vehicle relay apparatus 101C, upon receiving the PNC information P21 from the in-vehicle relay apparatus 101A, the relay unit 11 outputs the received PNC information P21 to the notification unit 23 and the update unit 24.

For example, the notification unit 23 does not perform notification processing if the in-vehicle relay apparatus 101C, which includes the notification unit 23, needs to exit sleep mode and no in-vehicle device 202 with the same PNCID as the new PNCID is connected to another in-vehicle relay apparatus 101.

More specifically, upon receiving the PNC information P21 from the relay unit 11, the notification unit 23 determines that no in-vehicle device 202 with the same PNCID as the new PNCID is connected to another in-vehicle relay apparatus 101, and does not perform notification processing.

Upon receiving the PNC information P21 from the relay unit 11, the update unit 24 updates the PNC list L11 in the storage unit 13.

Specifically, for example, the update unit 24 registers the new PNCID indicated by the PNC information P21 received from the relay unit 11 in the PNC list L11.

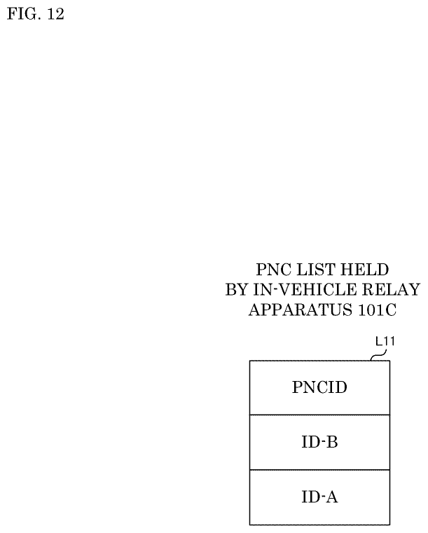

FIG. 12 is a diagram illustrating an example of an updated PNC list held by the in-vehicle relay apparatus according to the embodiment of the present disclosure. FIG. 12 shows the updated PNC list L11.

As shown in FIG. 12, in the updated PNC list L11, compared to the PNC list L11 shown in FIG. 6, the PNCID “A” is additionally registered.

Note that, in the in-vehicle system 301 shown in FIG. 9, if it is assumed that an in-vehicle device 202 with the same PNCID as the new PNCID is connected to the in-vehicle relay apparatus 101A, the in-vehicle relay apparatus 101C performs the following notification processing.

Specifically, in the in-vehicle relay apparatus 101A shown in FIG. 11, if an in-vehicle device 202 with the same PNCID as the new PNCID indicated by the request information received from the relay unit 11 is connected to the in-vehicle relay apparatus 101A, which includes the response unit 42, the response unit 42 transmits PNC information (hereinafter also referred to as “PNC information P22”) indicating that the in-vehicle device 202 is connected to the in-vehicle relay apparatus 101A, which includes the response unit 42, to the in-vehicle relay apparatus 101C via the relay unit 41.

FIG. 3 is referenced again. In the in-vehicle relay apparatus 101C, upon receiving the PNC information P22 from the in-vehicle relay apparatus 101A via the relay unit 11, the notification unit 23 determines that an in-vehicle device 202 with the same PNCID as the new PNCID is connected to another in-vehicle relay apparatus 101, i.e., the in-vehicle relay apparatus 101A.

Thereafter, the notification unit 23 transmits connection destination information to the navigation apparatus via the relay unit 11, indicating that the connection destination of the new device is to be changed to the in-vehicle relay apparatus 101A and that the power efficiency of the vehicle 1 has decreased due to the connection of the new device to the in-vehicle relay apparatus 101C.

### Operation Flow

Next, the flow of operations of the apparatuses in the in-vehicle system 301 according to the embodiment of the present disclosure will be described with reference to the drawings.

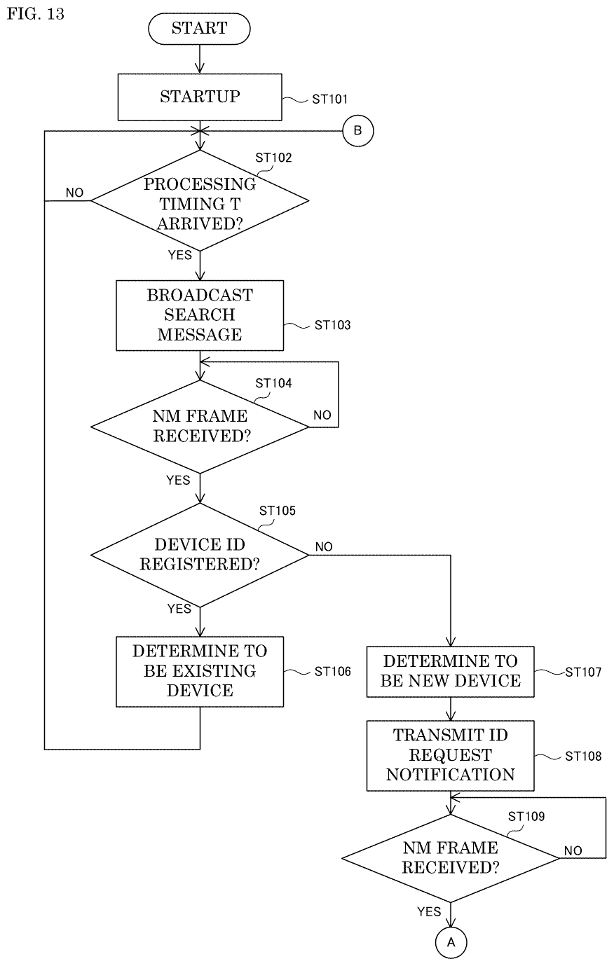

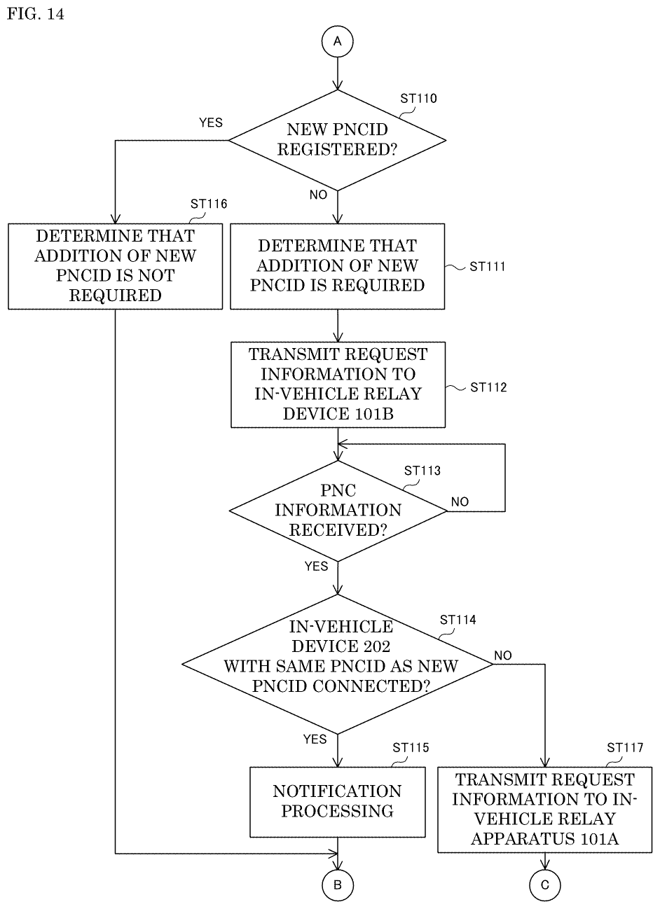

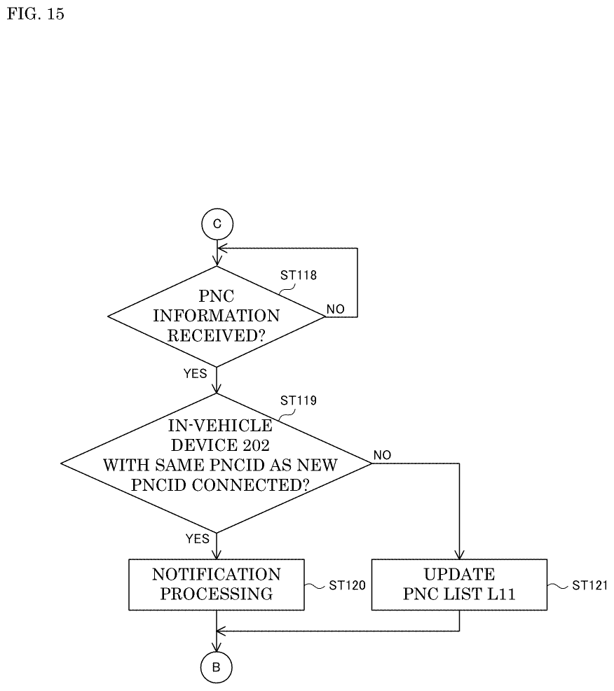

FIGS. 13, 14, and 15 are flowcharts defining an example of an operation procedure when an in-vehicle relay apparatus according to the embodiment of the present disclosure performs notification processing.

As shown in FIGS. 13, 14 and 15, first, the in-vehicle relay apparatus 101C is started up when power is supplied from the ignition power supply (step ST101).

Next, the in-vehicle relay apparatus 101C waits for the arrival of a processing timing T for detection processing (NO in step ST102).

Thereafter, when the processing timing T arrives (YES in step ST102), the in-vehicle relay apparatus 101C broadcasts a search message for detecting the addition of a new device to one or more in-vehicle devices 202 connected to the in-vehicle relay apparatus 101C (step ST103).

Next, the in-vehicle relay apparatus 101C waits for the reception of an NM frame from one or more in-vehicle devices 202 connected to the in-vehicle relay apparatus 101C (NO in step ST104).

Next, upon receiving an NM frame from an in-vehicle device 202 connected to the in-vehicle relay apparatus 101C (YES in step ST104), the in-vehicle relay apparatus 101C checks whether or not the device ID contained in the received NM frame is registered in the device list L20 in the storage unit 13 (step ST105).

Thereafter, if the device ID contained in the received NM frame is registered in the device list L20 (YES in step ST105), the in-vehicle relay apparatus 101C determines that the in-vehicle device 202 that transmitted the NM frame is an existing device (step ST106), and waits for the arrival of the next processing timing T (NO in step ST102).

On the other hand, if the device ID contained in the received NM frame is not registered in the device list L20 (NO in step ST105), the in-vehicle relay apparatus 101C determines that the in-vehicle device 202 that transmitted the NM frame is a new device (step ST107).

Next, upon detecting the addition of a new device, the in-vehicle relay apparatus 101C transmits an ID request notification, indicating a request to transmit a PNCID, to the new device (step ST108).

Next, the in-vehicle relay apparatus 101C waits for the reception of an NM frame that contains a PNCID from the new device (NO in step ST109).

Next, upon receiving an NM frame that contains a PNCID from the new device (YES in step ST109), the in-vehicle relay apparatus 101C checks whether or not the PNCID is registered in the PNC list L11 in the storage unit 13 (step ST110).

Thereafter, if the PNCID contained in the NM frame received from the new device is not registered in the PNC list L11 (NO in step ST110), the in-vehicle relay apparatus 101C determines that the PNCID needs to be added to the PNC list L11 (step ST111).

Next, the in-vehicle relay apparatus 101C transmits, to the in-vehicle relay apparatus 101B, request information for requesting PNC information regarding the PNCID of the in-vehicle device 202 already connected to the in-vehicle relay apparatus 101B (step ST112).

Next, the in-vehicle relay apparatus 101C waits for the reception of the PNC information from the in-vehicle relay apparatus 101B (NO in step ST113).

Next, upon receiving the PNC information from the in-vehicle relay apparatus 101B (YES in step ST113), the in-vehicle relay apparatus 101C checks whether or not an in-vehicle device 202 with the same PNCID as the PNCID of the new device, i.e., the new PNCID, is connected to the in-vehicle relay apparatus 101B, by referencing the received PNC information (step ST114).

Thereafter, if an in-vehicle device 202 with the same PNCID as the new PNCID is connected to the in-vehicle relay apparatus 101B (YES in step ST114), the in-vehicle relay apparatus 101C performs notification processing to provide a notification indicating that the connection destination of the new device is to be changed to the in-vehicle relay apparatus 101B and indicating information regarding the power saving of the vehicle 1 (step ST115), and waits for the arrival of the next processing timing T (NO in step ST102).

On the other hand, if no in-vehicle device 202 with the same PNCID as the new PNCID is connected to the in-vehicle relay apparatus 101B (NO in step ST114), the in-vehicle relay apparatus 101C transmits request information to the in-vehicle relay apparatus 101A (step ST117).

Next, the in-vehicle relay apparatus 101C waits for the reception of the PNC information from the in-vehicle relay apparatus 101A (NO in step ST118).

Next, upon receiving PNC information from the in-vehicle relay apparatus 101A (YES in step ST118), the in-vehicle relay apparatus 101C checks whether or not an in-vehicle device 202 with the same PNCID as the new PNCID is connected to the in-vehicle relay apparatus 101A by referencing the received PNC information (step ST119).

Thereafter, if an in-vehicle device 202 with the same PNCID as the new PNCID is connected to the in-vehicle relay apparatus 101A (YES in step ST119), the in-vehicle relay apparatus 101C performs notification processing to provide a notification indicating that the connection destination of the new device is to be changed to the in-vehicle relay apparatus 101A and indicating information regarding the power saving of the vehicle 1 (step ST120), and waits for the arrival of the next processing timing T (NO in step ST102).

On the other hand, if no in-vehicle device 202 with the same PNCID as the new PNCID is connected to the in-vehicle relay apparatus 101A (NO in step ST119), the in-vehicle relay apparatus 101C updates the PNC list L11 (step ST121) and waits for the arrival of the next processing timing T (NO in step ST102).

Also, if the PNCID contained in the NM frame received from the new device is registered in the PNC list L11 (YES in step ST110), the in-vehicle relay apparatus 101C determines that it is unnecessary to add the PNCID to the PNC list L11 (step ST116) and waits for the arrival of the next processing timing T (NO in step ST102).

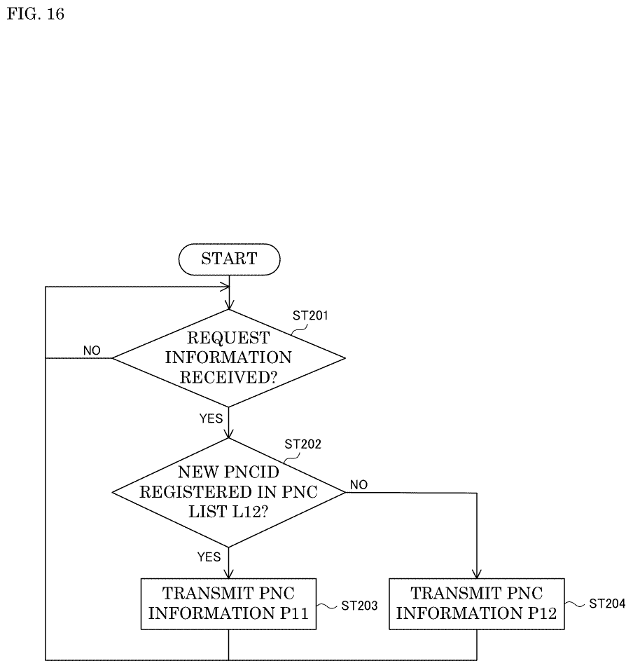

FIG. 16 is a flowchart defining an example of an operation procedure through which the in-vehicle relay apparatus according to the embodiment of the present disclosure performs processing to transmit PNC information. FIG. 16 shows a case where the in-vehicle relay apparatus 101B performs processing to transmit PNC information. The operation procedure through which the in-vehicle relay apparatus 101A performs processing to transmit PNC information is similar to the operation procedure through which the in-vehicle relay apparatus 101B performs processing to transmit PNC information.

As shown in FIG. 16, first, the in-vehicle relay apparatus 101B waits for the reception of request information from the in-vehicle relay apparatus 101C (NO in step ST201).

Next, upon receiving request information from the in-vehicle relay apparatus 101C (YES in step ST201), the in-vehicle relay apparatus 101B checks whether or not the new PNCID indicated by the received request information is registered in the PNC list L12 in the storage unit 33 (step ST202).

If the new PNCID indicated by the received request information is registered in the PNC list L12 (YES in step ST202), the in-vehicle relay apparatus 101B transmits PNC information P11 indicating that an in-vehicle device 202 with the same PNCID as the new PNCID is connected to the in-vehicle relay apparatus 101B, to the in-vehicle relay apparatus 101C (step ST203), and waits for the reception of new request information from the in-vehicle relay apparatus 101C (NO in step ST201).

On the other hand, if the new PNCID indicated by the received request information is not registered in the PNC list L12 (NO in step ST202), the in-vehicle relay apparatus 101B transmits PNC information P12 indicating that no in-vehicle device 202 with the same PNCID as the new PNCID is connected to the in-vehicle relay apparatus 101B, to the in-vehicle relay apparatus 101C (step ST204), and waits for the reception of new request information from the in-vehicle relay apparatus 101C (NO in step ST201).

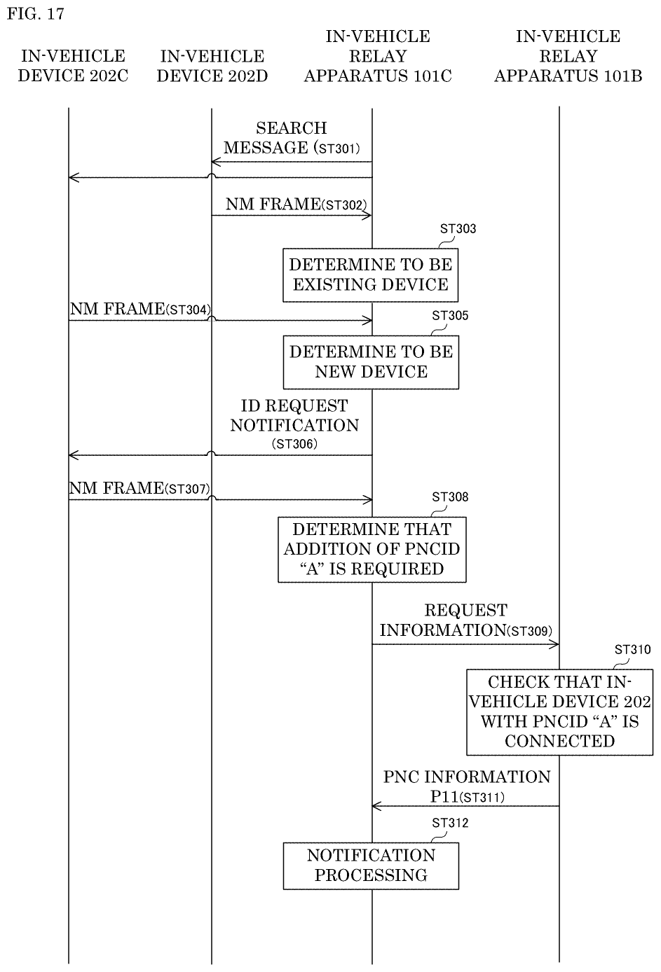

FIG. 17 is a diagram illustrating an example of a processing sequence of in-vehicle relay apparatuses and in-vehicle devices in the in-vehicle system according to the embodiment of the present disclosure. FIG. 17 shows the processing performed by the in-vehicle relay apparatuses 101B and 101C and the in-vehicle devices 202C and 202D in the in-vehicle system 301 shown in FIG. 4.

As shown in FIG. 17, first, the in-vehicle relay apparatus 101C broadcasts a search message for detecting the addition of a new device to each of the in-vehicle devices 202 connected to the in-vehicle relay apparatus 101C (step ST301).

Next, upon receiving the search message from the in-vehicle relay apparatus 101C, the in-vehicle device 202C transmits an NM frame containing the device ID of the in-vehicle device 202C to the in-vehicle relay apparatus 101C (step ST302).

Next, upon receiving the NM frame containing the device ID from the in-vehicle device 202C, the in-vehicle relay apparatus 101C references the device list L20 in the storage unit 13 to determine whether or not the in-vehicle device 202C is a new device. Here, it is assumed that the in-vehicle relay apparatus 101C determines that the in-vehicle device 202C is an existing device (step ST303).

Upon receiving the search message from the in-vehicle relay apparatus 101C, the in-vehicle device 202D transmits an NM frame containing the device ID of the in-vehicle device 202D to the in-vehicle relay apparatus 101C (step ST304).

Next, upon receiving the NM frame containing the device ID from the in-vehicle device 202C, the in-vehicle relay apparatus 101C references the device list L20 in the storage unit 13 to determine whether or not the in-vehicle device 202D is a new device. Here, it is assumed that the in-vehicle relay apparatus 101C determines that the in-vehicle device 202D is a new device (step ST305).

Next, the in-vehicle relay apparatus 101C transmits an ID request notification, indicating a request to transmit a PNCID, to the in-vehicle device 202D (step ST306).

Next, upon receiving the ID request notification from the in-vehicle relay apparatus 101C, the in-vehicle device 202D transmits an NM frame containing the PNCID of the in-vehicle device 202D to the in-vehicle relay apparatus 101C. Here, it is assumed that the PNCID of the in-vehicle device 202D is “A” (step ST307).

Next, upon receiving an NM frame containing the PNCID “A” from the in-vehicle device 202D, the in-vehicle relay apparatus 101C references the PNC list L11 in the storage unit 13 to determine whether or not it is necessary to add the PNCID “A” to the PNC list L11. Here, it is assumed that the in-vehicle relay apparatus 101C determines that it is necessary to add the PNCID “A” to the PNC list L11 (step ST308).

Next, upon determining that it is necessary to add the PNCID “A” to the PNC list L11, the in-vehicle relay apparatus 101C transmits request information for requesting PNC information, containing the PNCID “A”, to the in-vehicle relay apparatus 101B (step ST309).

Next, upon receiving the request information from the in-vehicle relay apparatus 101C, the in-vehicle relay apparatus 101B checks whether or not an in-vehicle device 202 with the same PNCID as the PNCID “A” contained in the received request information is connected to the in-vehicle relay apparatus 101B. Here, it is assumed that the in-vehicle device 202 is connected to the in-vehicle relay apparatus 101B (step ST310).

Next, the in-vehicle relay apparatus 101B transmits, to the in-vehicle relay apparatus 101C, PNC information P11 indicating that the in-vehicle device 202 with the same PNCID as the PNCID “A” is connected to the in-vehicle relay apparatus 101B (step ST311).

Next, upon receiving the PNC information P11 from the in-vehicle relay apparatus 101B, the in-vehicle relay apparatus 101C performs notification processing to provide a notification indicating that the connection destination of the new device is to be changed to the in-vehicle relay apparatus 101B and indicating information regarding the power saving of the vehicle 1 (step ST312).

Note that, in the in-vehicle system 301 according to the embodiment of the present disclosure, the in-vehicle relay apparatus 101C includes the detection unit 21, the request unit 22, and the notification unit 23, but the present disclosure is not limited to this configuration. Instead of the in-vehicle relay apparatus 101C, or in addition to the in-vehicle relay apparatus 101C, at least one of the in-vehicle relay apparatus 101A and the in-vehicle relay apparatus 101B may include the detection unit 21, the request unit 22, and the notification unit 23. In the in-vehicle network 401, an apparatus other than the in-vehicle relay apparatuses 101A, 101B, and 101C may include the detection unit 21, the request unit 22, and the notification unit 23.

Also, in the in-vehicle system 301 according to the embodiment of the present disclosure, the in-vehicle relay apparatuses 101A and 101B have the function of transmitting PNC information upon receiving request information from the in-vehicle relay apparatus 101C, but the present disclosure is not limited to this configuration. As described above, when an apparatus other than the in-vehicle relay apparatus 101C includes the detection unit 21, the request unit 22, and the notification unit 23, the in-vehicle relay apparatus 101C may be configured to have the above functions. Specifically, the in-vehicle relay apparatus 101C may include a receiving unit that receives request information, and a response unit that, when the receiving unit receives the request information, transmits PNC information to the origin from which the request information has been transmitted. In this case, for example, in the in-vehicle relay apparatus 101C, the relay unit 11 corresponds to the receiving unit, and the processing unit 12 includes the response unit.

Also, in the in-vehicle system 301 according to the embodiment of the present disclosure, the in-vehicle relay apparatuses 101 and the in-vehicle devices 202 are configured to form a PNC that conforms to the AUTOSAR standard, but the present disclosure is not limited to this configuration. The in-vehicle relay apparatus 101 and the in-vehicle device 202 may be configured to form a network that conforms to a standard other than AUTOSAR. In this case, for example, when an in-vehicle device 202 with a new ID different from the ID of the network to which the in-vehicle relay apparatus 101C belongs is connected to the in-vehicle relay apparatus 101C, the in-vehicle relay apparatus 101C performs notification processing.

Also, in the in-vehicle system 301 according to the embodiment of the present disclosure, the in-vehicle relay apparatus 101C is configured to perform notification processing when it is necessary for the in-vehicle relay apparatus 101C to exit the power saving mode thereof and an in-vehicle device 202 with the same PNCID as the new PNCID is connected to another in-vehicle relay apparatus 101, but the present disclosure is not limited to this configuration. The in-vehicle relay apparatus 101C may be configured to perform notification processing when it is necessary for the in-vehicle relay apparatus 101C to exit the power saving mode thereof, regardless of whether or not an in-vehicle device 202 with the same PNCID as the new PNCID is connected to another in-vehicle relay apparatus 101.

Also, in the in-vehicle system 301 according to the embodiment of the present disclosure, the in-vehicle relay apparatus 101C is configured to, when an in-vehicle device 202 with a new PNCID is connected to the in-vehicle relay apparatus 101C, perform processing to request PNC information from another in-vehicle relay apparatus 101, but the present disclosure is not limited to this configuration. For example, when the connection relationship between the other in-vehicle relay apparatus 101 and the in-vehicle device 202 is fixed, the storage unit 13 of the in-vehicle relay apparatus 101C may be configured to store the PNC information of the other in-vehicle relay apparatus 101 in advance. In this case, the in-vehicle relay apparatus 101C does not perform processing to request PNC information from the other in-vehicle relay apparatus 101.

Also, in the in-vehicle system 301 according to the embodiment of the present disclosure, the in-vehicle relay apparatus 101C is configured to provide a notification of information regarding the power saving of the vehicle 1 in notification processing, but the present disclosure is not limited to this configuration. The in-vehicle relay apparatus 101C may be configured not to provide a notification of the information.

The foregoing embodiments are to be construed in all respects as illustrative and not restrictive. The scope of the present disclosure is defined by the claims rather than the description above, and is intended to include all modifications within the meaning and scope of the claims and equivalents thereof.

Each type of processing (each function) in the above embodiment is realized by a processing circuitry including one or more processors. The processing circuitry may be constituted by an integrated circuit or the like that combines one or more memories, various analog circuits, and various digital circuits, in addition to the one or more processors. The one or more memories store programs (instructions) that cause the one or more processors to execute each type of the above processing. The one or more processors may execute each type of the above processing according to the programs read out from the one or more memories, or may execute each type of the above processing according to a logic circuit designed in advance to execute each type of the above processing. The processors may be various processors suitable for computer control, such as a CPU (Central Processing Unit), a GPU (Graphics Processing Unit), a DSP (Digital Signal Processor), an FPGA (Field Programmable Gate Array), and an ASIC (Application Specific Integrated Circuit). Note that a plurality of physically separated processors may cooperate with each other to execute each type of the above processing. For example, the processors installed in a plurality of physically separate computers may cooperate with each other via a network such as a LAN (Local Area Network), a WAN (Wide Area Network), or the internet to execute each type of the above processing. The above programs may be installed in the memories via the network from an external server device or the like, or may be distributed in a state stored on a recording medium such as a CD-ROM (Compact Disc Read Only Memory), a DVD-ROM (Digital Versatile Disk Read Only Memory), or semiconductor memory, and installed in the memories from the recording medium.

The above description includes characteristics described in the following supplementary notes.

### Supplementary Note 1

An in-vehicle apparatus used in an in-vehicle network that includes a plurality of in-vehicle relay apparatuses that relay frames transmitted and received between in-vehicle devices,
each of the plurality of in-vehicle relay apparatuses being configured to operate in a power saving mode when a predetermined condition is satisfied,
the in-vehicle apparatus including:
a processing circuitry,
the processing circuitry being configured to
   in a state where existing devices each being an in-vehicle device are connected to an in-vehicle relay apparatus of the plurality of in-vehicle relay apparatuses, detect addition of an in-vehicle device other than the existing devices to the in-vehicle network; and
   when a target relay apparatus, which is the in-vehicle relay apparatus to which the existing devices are connected, needs to exit the power saving mode due to a new device, which is an in-vehicle device and whose addition has been detected by the detection unit, having been newly connected to the target relay apparatus, perform notification processing to provide a notification indicating that a connection destination of the new device is to be changed to an in-vehicle relay apparatus other than the target relay apparatus, of the plurality of in-vehicle relay apparatuses.

What is claimed is:

1. An in-vehicle apparatus used in an in-vehicle network that includes a plurality of in vehicle relay apparatuses that relay frames transmitted and received between in-vehicle devices,
each of the plurality of in vehicle relay apparatuses being configured to operate in a power saving mode when a predetermined condition is satisfied,
the in-vehicle apparatus comprising:
a detection unit made of a circuitry configured to, in a state where existing devices each being an in-vehicle device are connected to an in-vehicle relay apparatus of the plurality of in-vehicle relay apparatuses, detect addition of an in-vehicle device other than the existing devices to the in-vehicle network; and
a notification unit made of a circuitry configured to, when a target relay apparatus, which is the in-vehicle relay apparatus to which the existing devices are connected, needs to exit the power saving mode due to a new device, which is an in-vehicle device and whose addition has been detected by the detection unit, having been newly connected to the target relay apparatus, perform notification processing to provide a notification indicating that a connection destination of the new device is to be changed to an in-vehicle relay apparatus other than the target relay apparatus, of the plurality of in vehicle relay apparatuses.

2. The in-vehicle apparatus according to claim 1,
wherein the notification unit performs the notification processing when an in-vehicle device with a new PNCID different from PNCIDs of the existing devices is connected to the target relay apparatus as the new device, the PNCIDs conforming to the AUTOSAR standard.

3. The in-vehicle apparatus according to claim 1,
wherein the notification unit performs the notification processing when the target relay apparatus needs to exit the power saving mode and an in-vehicle device with the same PNCID as a new PNCID different from PNCIDs of the existing devices is connected to another in-vehicle relay apparatus of the plurality of in-vehicle relay apparatuses, the PNCIDs conforming to the AUTOSAR standard, and
the notification unit does not perform the notification processing when the target relay apparatus needs to exit the power saving mode and no in-vehicle device with the same PNCID as the new PNCID is connected to another in-vehicle relay apparatus of the plurality of in-vehicle relay apparatuses.

4. The in-vehicle apparatus according to claim 1, further including;
a request unit made of a circuitry configured to, when an in-vehicle device with a new PNCID different from PNCIDs of the existing devices is connected to the target relay apparatus as the new device, perform processing to request information regarding PNCIDs of in-vehicle devices already connected to another in-vehicle relay apparatus of the plurality of in-vehicle relay apparatuses, from the other in-vehicle relay apparatus, the PNCIDs conforming to the AUTOSAR standard.

5. The in-vehicle apparatus according to claim 1, the in-vehicle apparatus including one of the plurality of in-vehicle relay apparatuses,
the in-vehicle apparatus further comprising:
a receiving unit made of a circuitry configured to receive request information for requesting PNC information regarding PNCIDs of in-vehicle devices already connected to an in-vehicle relay apparatus of the plurality of in-vehicle relay apparatuses, from the in-vehicle apparatus, the PNCIDs conforming to the AUTOSAR standard; and
a response unit made of a circuitry configured to, when the receiving unit receives the request information, transmit the PNC information to an origin from which the request information has been transmitted.

6. The in-vehicle apparatus according to claim 1,
wherein, in the notification processing, the notification unit further provides a notification of information regarding power saving of a vehicle in which the in-vehicle apparatus is mounted.

7. A connection destination notification method for an in-vehicle apparatus used in an in-vehicle network that includes a plurality of in-vehicle relay apparatuses that relay frames transmitted and received between in-vehicle devices,
each of the plurality of in vehicle relay apparatuses being configured to operate in a power saving mode when a predetermined condition is satisfied,
the connection destination notification method comprising the steps of:
in a state where existing devices each being an in-vehicle device are connected to an in-vehicle relay apparatus of the plurality of in-vehicle relay apparatuses, detecting addition of an in-vehicle device other than the existing devices to the in-vehicle network; and
when a target relay apparatus, which is the in-vehicle relay apparatus to which the existing devices are connected, needs to exit the power saving mode due to a new device, which is an in-vehicle device and whose addition has been detected, having been newly connected to the target relay apparatus, performing notification processing to provide a notification indicating that a connection destination of the new device is to be changed to an in-vehicle relay apparatus other than the target relay apparatus, of the plurality of in-vehicle relay apparatuses.

8. A computer program product used in an in-vehicle apparatus of an in-vehicle network that includes a plurality of in-vehicle relay apparatuses that relay frames transmitted and received between in vehicle devices, wherein each of the plurality of in-vehicle relay apparatuses is configured to operate in a power saving mode when a predetermined condition is satisfied,
the computer program product comprising a non transitory, machine-readable medium storing instructions which, when executed by at least one programmable processor, causes at least one programmable processor to perform operations comprising:
detecting, in a state where existing devices, which are the in-vehicle devices, are connected to an in-vehicle relay apparatus of the plurality of in-vehicle relay apparatuses, an addition of an in-vehicle device other than the existing devices to the in-vehicle network; and
notifying, when a target relay apparatus, which is the in-vehicle relay apparatus to which the existing devices are connected, needs to exit the power saving mode due to a new device, which is an in-vehicle device and whose addition has been detected, having been newly connected to the target relay apparatus, and to provide a notification indicating that a connection destination of the new device is to be changed to an in-vehicle relay apparatus other than the target relay apparatus, of the plurality of in-vehicle relay apparatuses.
